(19) United States
(12) Patent Application Publication
(10) Pub. No.: US 2011/0316888 A1
(43) Pub. Date: Dec. 29, 2011

(54) MOBILE DEVICE USER INTERFACE COMBINING INPUT FROM MOTION SENSORS AND OTHER CONTROLS

(75) Inventors: David SACHS, New York, CA (US); Steven S. NASIRI, Saratoga, CA (US)

(73) Assignee: INVENSENSE, INC., Sunnyvale, CA (US)

(21) Appl. No.: 13/171,298

(22) Filed: Jun. 28, 2011

Related U.S. Application Data
(60) Provisional application No. 61/359,197, filed on Jun. 28, 2010.

(51) Int. Cl. G09G 5/00; G06F 3/041

(52) U.S. Cl. 345/667; 345/156; 345/173; 345/174; 345/684

(57) ABSTRACT

Various embodiments provide user interfaces for mobile devices which combine input from motion sensors and other input controls. In one aspect, a handheld electronic device includes a display operative to display an image, an input control operative to sense a contact motion of the user with the device, a set of motion sensors sensing rotational rate of the device around at least three axes of the device and linear acceleration along at least three axes of the device, and a subsystem capable of facilitating interaction with the device based on combined sensor data. The combined sensor data includes motion data derived from at least one of the motion sensors and contact data derived from the contact motion sensed by the input control.

### CROSS REFERENCE TO RELATED APPLICATIONS

This application claims the benefit of U.S. Provisional Application No. 61/359,197, filed Jun. 28, 2010, entitled, “Combining a Touchscreen with Motion Sensors to Make a More Efficient UI”, which is incorporated herein by reference in its entirety.

### BACKGROUND OF THE INVENTION

Handheld electronic devices are used in a wide variety of applications and environments. The ubiquity of such devices as mobile phones, digital still cameras and video cameras, handheld music and media players, portable video game devices and controllers, mobile internet devices (MIDs), personal navigation devices (PNDs), and other handheld devices speaks the popularity and desire for these types of devices. These devices may include a variety of types of input controls which allow the user to control functions of the devices. For example, many devices now use touchscreens, which are display screens including a touch-sensitive sensor that detects contact of the user with the screen surface. Devices can also use other input controls such as buttons or keys, trackballs, optical sensors, etc. However, controlling the multitude of functions of a handheld device can often be awkward or clumsy, due to the small size of the devices. For example, handheld devices with a touchscreen typically require two hands of the user to be effectively used, as well as the close attention of the user when operating the device.

Motion sensors, such as inertial sensors like accelerometers or gyroscopes, can also be used in handheld electronic devices. Accelerometers can be used for measuring linear acceleration and gyroscopes can be used for measuring angular velocity of a moved handheld electronic device. The markets for motion sensors include mobile phones, video game controllers, personal digital assistants (PDAs), mobile internet devices (MIDs), personal navigational devices (PNDs), digital still cameras, digital video cameras, remote controls, and many more. For example, mobile phones may use accelerometers to detect the tilt of the device in space, which allows a video picture to be displayed in an orientation corresponding to the tilt. Video game console controllers may use accelerometers to detect motion of the hand controller that is used to provide input to a game. Picture and video stabilization is an important feature in even low- or mid-end digital cameras, where lens or image sensors are shifted to compensate for hand jittering measured by a gyroscope. Global positioning system (GPS) and location based service (LBS) applications rely on determining an accurate location of the device, and motion sensors may be needed when a GPS signal is attenuated or unavailable, or to enhance the accuracy of GPS location finding.

Although both motion sensors and touchscreens are becoming standard in handheld devices, user interface designers have not provided a way to make good use of both of these inputs to increase efficiency of user control over the device. In general, the touchscreen dominates the interaction of the user with the user interface and one or two unrelated features are controlled by an accelerometer, such as providing 90-degree tilting screen orientation or shaking of the device to trigger a function.

The minimal use of motion sensors for user interfaces has occurred partly because gyroscope motion sensors have not yet been exploited in user interfaces within handheld devices; most handheld devices only contain accelerometers and compasses, of which only the accelerometers are used for the user interface. Gyroscopes provide a clean motion tracking signal that can be used to control the user interface of a handheld device more precisely and reliably, opening up more possibilities. Gyroscope-based motion sensing has been described previously for use in controlling a handheld device. However, the described uses of motion sensors such as accelerometers and gyroscopes in user interfaces is limited, and do not allow more efficient ways of interacting with a device when used with other input devices such as touchscreens.

Most handheld devices rely on the user contacting a touchscreen or other input controls in providing input to the user interface. In one example, a picture, map, electronic book, or web page may be viewed on a touchscreen of a device such that the user may want to pan the displayed view to see different parts of an image, or zoom the view in certain parts of the image. Many current touchscreen implementations provide panning based on a user dragging a finger along the touchscreen, and provide zooming based on a multi-touch contact gesture such as a user “pinching” two fingers or opening two fingers on the screen. The panning implementation is problematic if the user wants to quickly pan through a large image or a large amount of data, since such panning requires many swipes across the screen with the thumb or finger. The zooming implementation is often awkward, for example, because requiring a multi-touch gesture to control the zooming does not allow use of the device with one hand.

Motion sensing can be used in some embodiments instead of the touchscreen or other input controls, which may make panning easier by using rotation of the device to look at different parts of the displayed image, or make zooming easier by using device rotation to zoom in and out of the current center of the image. However, the use of motion control over particular device functions includes its own inefficiencies. Thus, these separate uses of touchscreen or motion sensors does not make use of both of these input methods to increase effectiveness and efficiency of user interaction with the device.

### SUMMARY OF THE INVENTION

The present application relates to user interfaces of mobile devices which combine input from motion sensors and other input controls. In one aspect, a handheld electronic device includes a display operative to display an image, an input control operative to sense a contact motion of the user with the device, a set of motion sensors sensing rotational rate of the device around at least three axes of the device and linear acceleration along at least three axes of the device, and a subsystem capable of facilitating interaction with the device based on combined sensor data. The combined sensor data includes motion data derived from at least one of the motion sensors and contact data derived from the contact motion sensed by the input control.

In another aspect, a storage medium includes a software program, the software program capable of running at least partially on a handheld electronic device that comprises a touchscreen display operative to display an image and to sense contact on a surface of the touchscreen display, and a set of motion sensors sensing rotational rate around at least three axes and linear acceleration along at least three axes. The software program is capable of facilitating interaction with the device based on combined sensor data, the combined sensor data including motion data derived from at least one of the motion sensors and contact data derived from the contact sensed by the touchscreen display.

In another aspect, a method for providing interaction with a handheld electronic device includes sensing contact motion input from a user using an input control of the handheld electronic device. Motion of the device is sensed around at least one axis of the device using a set of motion sensors, the set of motion sensors operative to sense rotational rate around at least three axes of the device and linear acceleration along at least three axes of the device. Interaction with the device is provided based on combined sensor data, the combined sensor data including motion data derived from at least one of the motion sensors and contact data derived from the contact motion sensed by the input control.

Aspects of the described embodiments include a handheld electronic device allowing intuitive, fast, and accurate control of functions of the handheld device.

### BRIEF DESCRIPTION OF THE DRAWINGS

FIG. 1 is a perspective view of one example of a motion sensing handheld device suitable for use with described embodiments;

FIG. 2 is a block diagram of one embodiment of a motion sensing system suitable for use with described embodiments;

FIG. 3A is a top view of a first example of a handheld touchscreen device in accordance with some embodiments described herein;

FIG. 3B is a view of a user's hand manipulating the handheld touchscreen device of FIG. 3A in accordance with some embodiments described herein;

FIGS. 4A-4C are diagrammatic illustrations of displayed views of an example image illustrating interface functions controllable by described embodiments;

FIG. 5 is a view of a user's hand manipulating a second example of a handheld touchscreen device in accordance with some embodiments described herein; and

FIGS. 6A-6C are diagrammatic illustrations of sets of icons displayed on a display screen of a handheld electronic device and illustrating interface functions controllable by described embodiments.

### DETAILED DESCRIPTION

The present invention relates generally to user interfaces for mobile devices, and more specifically to interacting with mobile devices using input from motion sensors and other input controls. Various modifications to the preferred embodiments and the generic principles and features described herein will be readily apparent to those skilled in the art. Thus, the present embodiments are not intended to be limited to the examples shown but are to be accorded the widest scope consistent with the principles and features described herein.

Embodiments described herein provide enhanced functionality of a handheld electronic device by using device motion to assist control of functions of the device in conjunction with the use of input controls such as touchscreens or other controls. Control over device functions using motion of the device in combination with other input can allow easier and quicker control over those functions, as well as reduce wear on the device from use of the contact input controls. For example, a touchscreen can be used simultaneously with device motion in a way that makes a user interface more efficient. As used herein, the terms “include,” “including,” “for example,” “e.g.,” and variations thereof, are not intended to be terms of limitation, but rather are intended to be followed by the words “without limitation.”

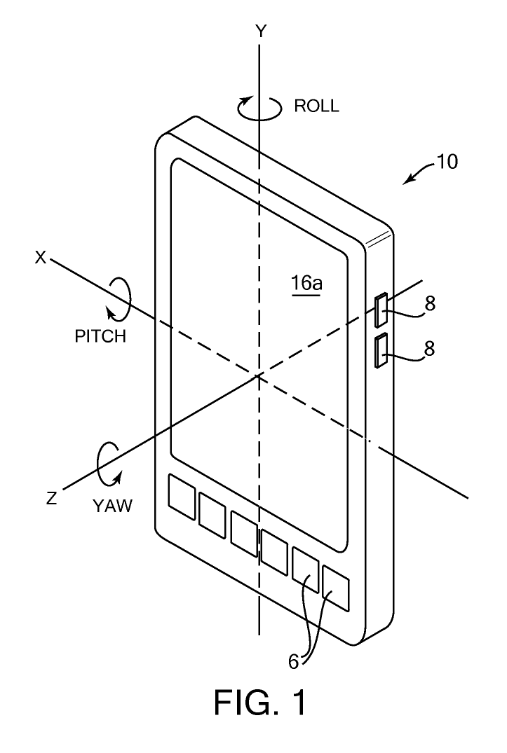

FIG. 1 is a perspective view of one example of a motion sensing handheld device 10 suitable for use with embodiments described herein. Device 10 can be held in one or more hands of a user to be operated, and can include a variety of different functions, as described below. In the example embodiment shown, device 10 can include a display screen 16a and physical buttons 6. In some embodiments, the display screen 16a is a touchscreen that includes a sensor system to detect the physical contact with the surface of the screen 16a, which is typically used to sense the contact of a user's finger, a stylus, or other user-controlled object. The touchscreen can detect a contact motion of the user, such as moving a finger or other object along the surface of the screen.

Some embodiments of device 10 can include physical buttons 6 on the front of the device 10 and/or one or more buttons 8 on one or both sides of the device 10. Buttons 6 and 8 can be contacted by the user, such as pressed and/or held, to activate or change different functions, modes of operation, states, or other abilities of the device 10. In other embodiments, other types of input controls can be used instead of or in addition to the touchscreen 16a or buttons 6 and 8.

In the described embodiments, a contact motion of the user is sensed by an input control and provides contact data to the user interface. The contact motion can be moving a finger or other object along a sensed surface, or the user moving an input control. For example, the contact motion can be moving a finger or other object on the touchscreen 16a, along a row of multiple buttons 6 or 8, or along a sensor strip, such that the direction and amount of contact motion of the user can be determined. In other embodiments, the contact motion can be moving a rotatable wheel or cylinder, trackball, linear slider, small joystick, or other manipulandum physically attached and/or in communication with the handheld device, such that direction and amount of contact motion of the user can be determined. In some embodiments, the input control can sense at least two directions of user motion. In some embodiments, the input control can sense a plurality of different positions of the user, e.g. at least three different positions.

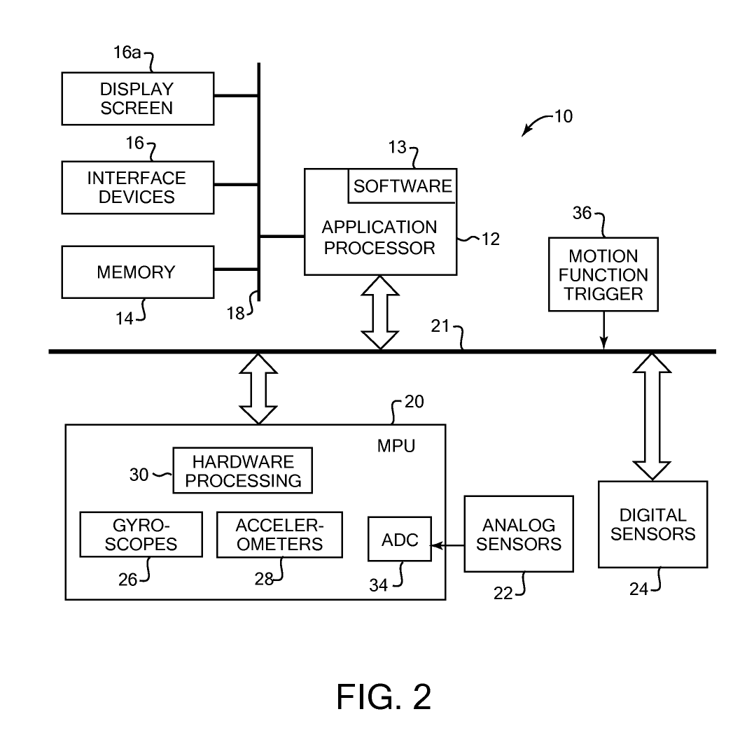

The contact motion is sensed by any of a variety of different input controls. An input control can include the touchscreen described above, and/or a row of multiple buttons 6 or 8 such that a contact motion of the user can be moving a finger or other object along a row of the buttons and the direction of movement can be determined. In some embodiments, a sensor strip can be provided alongside an edge of the display screen 16a to detect direction and magnitude of a user's contact motion along the strip, such as a capacitive strip or resistive strip. Other embodiments can use an optical sensor area to similarly sense user movement. In some embodiments, a physical manipulandum can be moved, such as a trackball, rotatable wheel, or joystick. Other embodiments of handheld device 10 can include different and/or additional input and output devices, as described below with respect to FIG. 2.

In accordance with the described embodiments, the device 10 also can be moved by the user in space, and this movement can be detected by motion sensors of the device as detailed below. As referred to herein, rotation of the device 10 can include pitch, roll, and yaw about the various rotational axes, as shown in FIG. 1. These axes can be defined differently in other embodiments. Furthermore, linear motions can be made along the linear axes x, y and z. Furthermore, these axes can be defined at various different positions on the device (for example translated or rotated with respect to the axes shown in FIG. 1, or otherwise transposed into any other coordinate system (whether rectangular, polar, or otherwise)), as appropriate for the hardware and software used by the device 10. Motion data can be derived from the motion sensors, and the motion data can be combined with contact data from sensed contact motion to provide combined sensor data for controlling the user interface, as described in greater detail below.

FIG. 2 is a block diagram of one example of device 10 or a motion sensing system suitable for use with aspects of the embodiments described herein. Device 10 can be implemented as a device or apparatus, such as a handheld device that can be moved in space by a user and its motion and/or orientation in space therefore sensed. For example, such a handheld device can be a mobile phone (e.g., cellular phone, a phone running on a local network, or any other telephone handset), wired telephone (e.g., a phone attached by a wire), personal digital assistant (PDA), video game player, video game controller, navigation device, mobile internet device (MID), personal navigation device (PND), digital still camera, digital video camera, binoculars, telephoto lens, portable music-, video-, or media-player, remote control, or other handheld device, or a device incorporating two or more of these functions or devices. In some embodiments, the device 10 is a self-contained device that includes its own display and other output devices in addition to input devices. In other embodiments, the handheld device 10 only functions in conjunction with a non-portable device such as a desktop computer, electronic tabletop device, server computer, etc. which can communicate with the moveable or handheld device 10, e.g., via network connections. The device may be capable of communicating via a wired connection using any type of wire-based communication protocol (e.g., serial transmissions, parallel transmissions, packet-based data communications), wireless connection (e.g., electromagnetic, infrared, or radio signals or radiation, or other wireless technology), or a combination of one or more wired connections and one or more wireless connections.

Device 10 includes an application processor 12, memory 14, interface devices 16, a motion processing unit 20, analog sensors 22, and digital sensors 24. The components of device 10 or various groups of components can be considered subsystems of the device 10. For example, the application processor 12 and memory 12, the motion processing unit 20, or the processors 12 and hardware processing block 30 can each be considered a subsystem.

Application processor 12 can be one or more microprocessors, central processing units (CPUs), or other processors which run software programs for the device 10 or for other applications related to the functionality of device 10. Different software application programs such as menu navigation software, games, camera function control, navigation software, and phone or a wide variety of other software and functional interfaces can be provided. In some embodiments, multiple different applications can be provided on a single device 10, and in some of those embodiments, multiple applications can run simultaneously on the device 10. Herein, any applications or interfaces are described as being accessed through a “user interface” running on the device, in which the user can access or control functions of one or more software programs and of the device with user input provided to the device and based on visual feedback displayed on the device. An operating system can also be considered a “software program” for the purposes of this document. Software programs may also include any software application or functionality, and any process, task, thread or other aspect of any operating system or application. A handheld device may have one or more operating systems running on it, or none. A software program may run fully on a handheld device, or may run partially on a handheld device and partially on an external system. In some embodiments, the application processor implements multiple different operating modes on the device 10, each mode allowing a different set of applications to be used on the device and/or a different set of functions to be controlled by the combined sensor data including motion data and contact data. As used herein, unless otherwise specifically stated, a “set” of items means one item, or any combination of two or more of the items.

Multiple layers of software can be provided on a computer readable medium such as electronic memory or other storage medium such as hard disk, optical disk, flash drive, etc., for use with the application processor 12 and facilitating interaction with the device using sensor data. For example, an operating system layer can be provided for the device 10 to control and manage system resources in real time, enable functions of application software and other layers, and interface application programs with other software and functions of the device 10. A motion algorithm layer can provide motion algorithms that provide lower-level processing for raw sensor data provided from the motion sensors and other sensors. A sensor device driver layer can provides a software interface to the hardware sensors of the device 10.

Some or all of these layers can be provided in software 13 of the processor 12. For example, in some embodiments, the processor 12 can implement motion processing and recognition based on sensor inputs from a motion processing unit (MPU™) 20 (described below). Other embodiments can allow a division of processing between the MPU 20 and the processor 12 as is appropriate for the applications and/or hardware used, where some of the layers (such as lower level software layers) are provided in the MPU. For example, in embodiments allowing processing by the MPU 20, an API layer can be implemented in layer 13 of processor 12 which allows communication of the states of application programs running on the processor 12 to the MPU 20 as well as API commands (e.g., over bus 21), allowing the MPU 20 to implement some or all of the motion processing and recognition. Some embodiments of API implementations in a motion detecting device are described in co-pending U.S. patent application Ser. No. 12/106,921, incorporated herein by reference in its entirety.

Device 10 also includes components for assisting the application processor 12, such as memory 14 (RAM, ROM, Flash, etc.) and interface devices 16. Memory 14 and interface devices 16 can be coupled to the application processor 12 by a bus 18, which can be a physical bus or a wireless connection. Interface devices 16 can be any of a variety of different devices providing input and/or output to a user, such as a display, audio speakers, printer, scanner, camera, computer network I/O device, other connected peripheral, etc. For example, the display 16a can be any type of display that outputs an image viewable by the user. The image can be any static, dynamic or multimedia signal, including text, pictures and video. The display may be integrated in the device and substantially immovable relative to the device, or may be attached to the device and may be extended away from the device, and/or movable with respect to a portion of the device. Examples of displays include any cathode ray tube (CRT), storage tube, bistable display, electronic paper, nixie tube display, vector display, flat panel display, vacuum fluorescent display (VF), light-emitting diode (LED) display, ELD display, plasma display panel (PDP), liquid crystal display (LCD), HPA display, thin-film transistor display (TFT), organic light-emitting diode displays (OLED), surface-conduction electron-emitter display (SED), laser display, carbon nanotube display, nanocrystal display, quantum dot-based display, or any combination of the foregoing that could be implemented or otherwise used in connection with a handheld device.

Interface devices 16 can include one or more physical input controls, which sense a contact motion of the user using the control and provide contact data derived from that motion to the device 10, such as to the application processor 12 and/or MPU 20. Such input controls can include a touchscreen sensor, sensor strip, trackball, rotatable wheel, joystick, optical sensor area, buttons, slider, knob, etc. For example, one interface control included in many described embodiments is a touchscreen sensor included in a touchscreen display, the sensor sensing input based on contact motion of the user with the display area of the touchscreen. Any of a variety of touchscreen sensing technology can be used for device 10, including capacitive, resistive, optical imaging, infrared, surface acoustic wave, or other technologies.

Device 10 also can include a motion processing unit (MPU™) 20. The MPU is a device including motion sensors that can measure motion of the device 10 (or portion thereof) in space. For example, the MPU can measure one or more axes of rotation and one or more axes of acceleration of the device. In preferred embodiments, at least some of the motion sensors are inertial sensors, such as gyroscopes and/or accelerometers. In some embodiments, the components to perform these functions are integrated in a single package. The MPU 20 can communicate motion sensor data to an interface bus 21, e.g., I2C or Serial Peripheral Interface (SPI) bus, to which the application processor 12 is also connected. In one embodiment, processor 12 is a controller or master of the bus 21. Some embodiments can provide bus 18 as the same bus as interface bus 21.

MPU 20 includes motion sensors, including one or more rotational motion sensors 26 and one or more linear motion sensors 28. In some embodiments, inertial motion sensors are used, where the rotational motion sensors sense rotational rate around axes and the linear motion sensors sense linear acceleration along axes of the device. For example, the rotational motion sensor can be gyroscopes and the linear motion sensors can be accelerometers.

Gyroscopes 26 can measure the angular velocity of the device 10 (or portion thereof) housing the gyroscopes 26. From one to three gyroscopes can typically be provided, depending on the motion that is desired to be sensed in a particular embodiment. Some implementations may employ more than three gyroscopes, for example to enhance accuracy, increase performance, or improve reliability. Some gyroscopes may be dynamically activated or deactivated, for example to control power usage or adapt to motion processing needs. The motion sensors sensing rotational rate may be implemented using a variety of technologies, including Micro Electro Mechanical Systems, piezoelectric, hemispherical resonator, tuning fork, quartz, carbon nanotubes, any other technology capable of producing devices that can sense motion of a rotational nature, or any combination of the foregoing.

Accelerometers 28 can measure the linear acceleration of the device 10 (or portion thereof) housing the accelerometers 28. From one to three accelerometers can typically be provided, depending on the motion that is desired to be sensed in a particular embodiment. Some implementations may employ more than three accelerometers, for example to enhance accuracy, increase performance, or improve reliability. Some accelerometers may be dynamically activated or deactivated, for example to control power usage or adapt to motion processing needs. Accelerometers are widely known in the art and can be implemented using any known accelerometer manufacturing technology and/or any other technology capable of producing devices capable of sensing acceleration.

For example, if three gyroscopes 26 and three accelerometers 28 are used, then a 6-axis sensing device is provided providing sensing in all six degrees of freedom. In embodiments with more than three gyroscopes and/or more than three accelerometers, additional degrees of freedom (or sensing axes) can be provided, and/or additional sensor input can be provided for each of the six axis of motion.

In some embodiments, a set of motion sensors sensing rotational rate around at least three axes and linear acceleration along at least three axes are integrated in a single module. In one implementation, the module is integrated in a single package, or otherwise enclosed in a single package. The single package module can consist of a single chip, or can include multiple individual devices that are integrated together in a common package. Examples of such multiple individual devices that may be integrated together in a common package include two or more dies that are attached to each other or otherwise integrated together, a printed circuit board (possibly including additional circuitry), a system on a chip (SOC), or any other combination of devices. For example, a single chip six-axis inertial measurement unit can be used in the MPU 20. In some embodiments the gyroscopes 26 and/or the accelerometers 28 can be implemented as MicroElectroMechanical Systems (MEMS). For example, three gyroscopes and three accelerometers can be integrated into a MEMS sensor wafer. Other embodiments may integrate more or less inertial sensors. Supporting hardware such as storage registers for the data from gyroscopes 26 and accelerometers 28 can also be provided. In some embodiments, additional or alternate types of rotational rate sensors and/or linear acceleration sensors can be used.

In some embodiments, the MPU 20 can also include a hardware processor or processing block 30. Hardware processing block 30 can include logic, microprocessors, or controllers to provide processing of motion sensor data in hardware. Memory dedicated to the MPU 20 can also be included in block 30. For example, motion algorithms, or parts of algorithms, may be implemented by block 30 in some embodiments, such as part of or all of motion recognition and motion gesture recognition. In such embodiments, an API can be provided for the application processor 12 to communicate desired sensor processing tasks to the MPU 20, as described above. Some embodiments can provide a sensor fusion algorithm that is implemented by the hardware processing block 30 to process all or multiple of the axes of motion of provided motion sensors (and/or other sensors such as magnetometers) to determine the movement of the handheld electronic device in space, i.e., combine inputs from multiple sensors to provide more robust sensing, an example of which is described in copending U.S. patent application Ser. No. 12/252,322, incorporated herein by reference in its entirety.

Some embodiments of MPU 20 can include a hardware buffer or other memory in the block 30 to store sensor data received from the gyroscopes 26 and accelerometers 28 and/or perform other data storage. Processing can be provided on the buffered sensor data and/or the data can be provided to the application processor 12. One or more motion function triggers 36, such as buttons 6 or 8 or other control, can be included in some embodiments to control whether or not motion data from motion sensors is input to the electronic device 10.

Examples of an MPU, integrated sensor units, and systems suitable for use with the present invention are described in co-pending U.S. patent application Ser. Nos. 11/774,488 and 12/106,921, all incorporated herein by reference in their entireties. Suitable implementations for MPU 20 in device 10 are available from InvenSense, Inc. of Sunnyvale, Calif.

The device 10 can also include other types of sensors. Analog sensors 22 and digital sensors 24 can be used to provide additional sensor data about the environment in which the device 10 is situated. For example, sensors such one or more barometers, compasses or magnetometers, temperature sensors, optical sensors (such as a camera sensor, infrared sensor, etc.), ultrasonic sensors, radio frequency sensors, or other types of sensors can be provided. For example, a compass or magnetometer sensor can provide an additional one, two, or three axes of sensing, such as two horizontal vectors and a third vertical vector. In the example implementation shown, digital sensors 24 can provide sensor data directly to the interface bus 21, while the analog sensors can be provide sensor data to an analog-to-digital converter (ADC) 34 which supplies the sensor data in digital form to the interface bus 21. In the example of FIG. 2, the ADC 34 is provided in the MPU 20, such that the ADC 34 can provide the converted digital data to hardware processing 30 of the MPU or to the bus 21. In other embodiments, the ADC 34 can be implemented elsewhere in device 10.

The received motion data can be processed using one or more of various processing techniques, and interpreted and/or prepared for or prepared to be acted upon other components of the handheld device. For example, copending U.S. patent application Nos. 11/774,488, 12/106,921, and 12/252,322, incorporated herein by reference in their entireties, describe various techniques and systems for processing and/or providing augmented sensor data, interpreting data and recognizing motion gestures or commands in the sensor data, and providing prepared data to an operating system, application, application processor or other component or software of the device, any or all of which can be used in the embodiments disclosed herein where applicable.

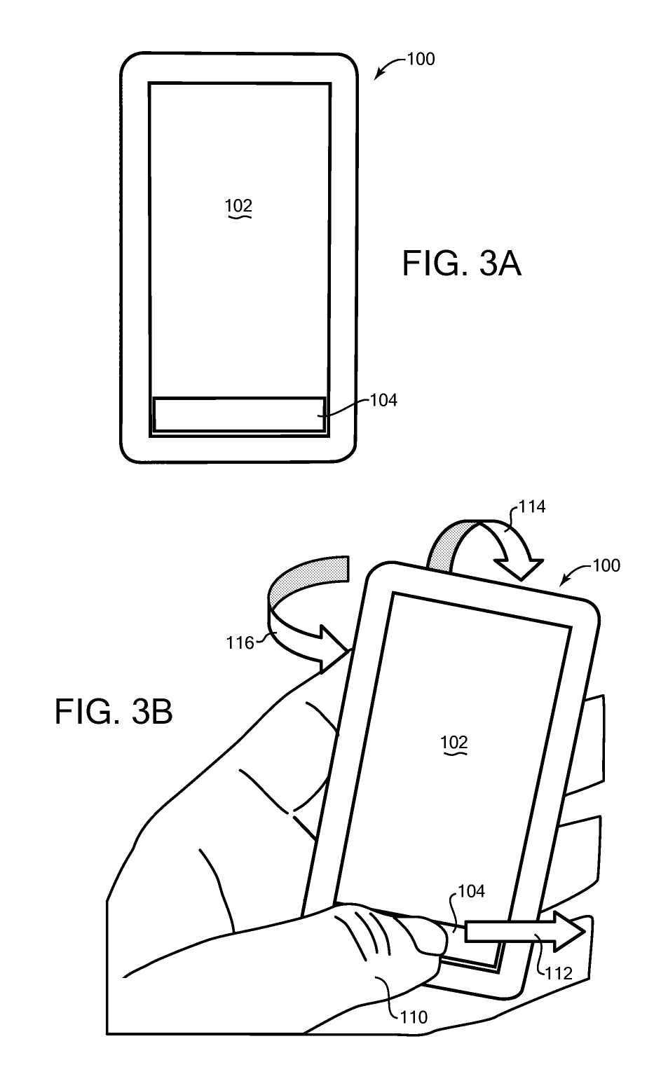

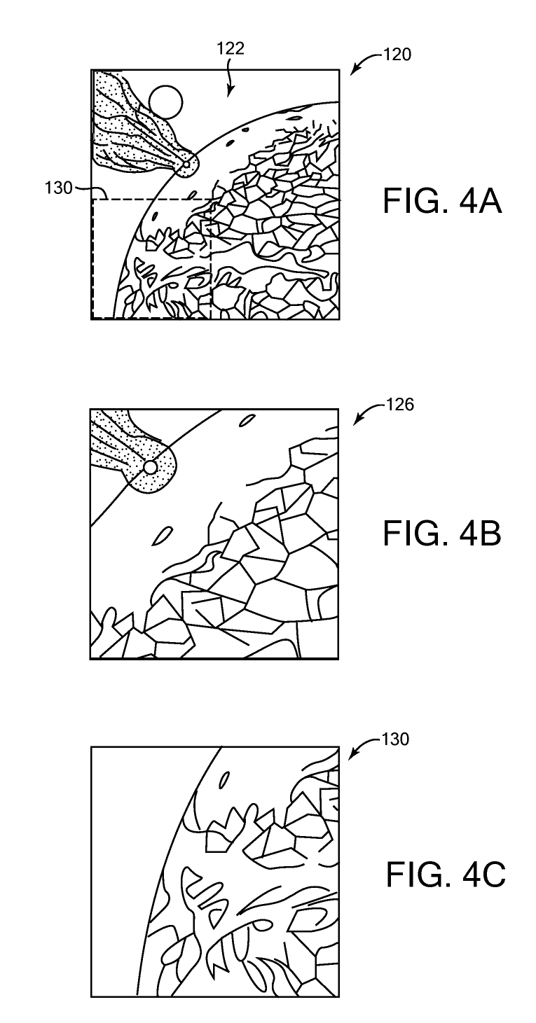

FIG. 3A is a top view of an example of a handheld touchscreen device 100 in accordance with some embodiments described herein. Device 100 is one example of a handheld device 10 which can be used to provide combined control inputs to a user interface as described below.

In the described embodiments, a contact motion of the user is sensed by an input control and provides contact data to the user interface and is combined with motion data to provide combined sensor data. Device 100 includes a touchscreen 102 which acts as an input control to allow a user to provide contact motion as input to the device to allow interaction with the device.

For example, touchscreen contact motions include touching, tapping, or pressing and holding the screen at a particular location to interact with (e.g., select or control) a displayed element, such as a displayed icon or button to activate an associated application program or an associated function of an application program or of the device 100. Another touchscreen contact motion is a “swipe” in which the user moves his or her finger in contact with the screen a short or long distance across the screen. This contact can be used to scroll an image or menu to display other parts or display elements, for example. Another touch screen contact motion is a “pinch” in which the user moves two fingers together or apart while touching the screen, to control a function such as zooming in or out, respectively. Other contact gestures can be used in other embodiments, such as circle motions on the touchscreen, triangular-shaped motions, right angle motions, handwriting motions, multiple taps or other gestures, etc. Herein, when describing input provided by one or more of a user's fingers, it is intended that other user-controlled objects besides fingers can alternatively be used to contact the device and provide input, such as other body parts, a stylus or other physical item, finger- or hand-appendage, etc.

With respect to some embodiments described herein, the touchscreen 102 can display a control region 104 as a displayed element. In some embodiments, the control region 104 can be an elongated shape that is displayed near or alongside an edge of display screen 102, such as a strip near the bottom edge of the screen as shown in FIG. 3A. The user can present a contact motion with the touchscreen within this control region 104 to provide particular input relevant to the user interface as described below. For example, a swipe of a user's finger can be made along the control region 104 for a particular distance (magnitude) in a particular direction. Other contact motions can also be made within control region 104 in some embodiments, such as taps, pinches, or other gestures. In other embodiments, multiple control regions 104 can be displayed on screen 102, such as a control region near each left and right edge and/or near both top and bottom edges of the screen. The multiple control regions can all perform the same functions, or can each perform a different function in various embodiments with the same or different types of control motions. In other embodiments, other shapes can be used for displayed control regions, such as circular, oval, hexagonal, or irregular shapes.

FIG. 3B is a view of a user's hand manipulating the handheld touchscreen device 100 in accordance with some embodiments described herein. In some embodiments, when the user touches an input control of the device 100, motion tracking becomes enabled for the device. This enabling allows the motion data provided by the motion sensors of the device which are tracking the motion of the device in space, such as gyroscopes 26 and/or accelerometers 28, to be interpreted by the device for purposes of user input and interface control. In this example, motion input is enabled while a user is contacting the control region 104 on the touchscreen, or can be enabled for a predetermined amount of time after the last contact with region 104. In some embodiments, the enabling of motion data can be activated by a separate motion function trigger by the user, such as a physical button on the device, separate from the input control providing the contact data for the combined data. Other embodiments can allow motion data to be input and processed without enabling.

In some embodiments, the user can provide a control motion in the control region 104 to provide contact data to be used as additional data for input and control of device operation. This contact data can be provided in addition to the enabling function of the motion data for input as described above. Also, the motion data can be input as the user moves the device 10 in space. Advantageously, the contact data and the motion data can be provided simultaneously to the device (or device processor(s)) and/or combined into combined sensor data as input for interacting with the device, such as controlling one or more functions of the device. In some embodiments, the combined sensor data is used to provide interaction with the device that includes interacting with a visual element displayed on the display, such as modifying an image displayed on the display. To make the interaction more intuitive for the user, e.g., device functions easier for the user to manipulate, visual feedback can be provided on the display to indicate the detected motion data and contact data.

In the example of FIG. 3B, to provide combined sensor data the user can slide a finger (such as a thumb 110 as shown) along the control region strip 104 in a particular direction (such as the direction of arrow 112 shown) while simultaneously moving the handheld device 100 in space, such as rotating the device about two or more its axes as shown.

The combined sensor data is used to facilitate interaction with the device, such as accessing or controlling functions and operations of the device. For example, the combined sensor data can be used such that the contact data controls at least one function of the user interface and the motion data controls at least one different, independent function of the user interface. For example, simultaneously rotating the handheld device while providing a contact motion on region 104 can control different and/or independent functions related to one or more displayed elements of the displayed view.

In some embodiments, the combined sensor data is used to provide independent functions that are zooming and panning functions. Zooming is bringing a displayed view of an image (or part of the image) closer or further away, where herein the term “zooming” may include both zooming in (closer view) and zooming out (further view). Panning is moving a displayed view of an image to the left, right, up and down. The zoomed and panned image may be a graphical image, a display of a set of visual elements, or a document such as text document, a PDF, a web page, or other similar types of documents. In some embodiments, data outside the currently displayed view of the image can be stored in a buffer to allow quick panning of an image.

In some embodiments, the contact motion of the thumb along the control region 104 in one direction (such as direction 112 as shown in FIG. 3B) can control zooming in of a view displayed on the display screen, and user contact motion along the control strip 104 in the opposite direction can control zooming out of the displayed view. Different directions can be assigned zooming in and out in other embodiments. Rotating the device can control panning (including scrolling) of the view displayed on screen 102. In some embodiments, rotation around the X axis of the device (pitch as referenced to FIG. 1) as indicated by arrow 114 may correspond to a vertical up and down panning motion causing the view to pan up and down across a displayed image, and rotation around the Y axis of the device (roll axis as referenced in FIG. 1) as indicated by arrow 116 may correspond to a horizontal side-to-side panning motion causing the view to pan left and right cross the displayed image. For example, in some embodiments, maintaining the device at a position that has been rotated about an axis relative to a starting or neutral position can cause continuous panning in the corresponding direction, until the device is rotated back to the starting position.

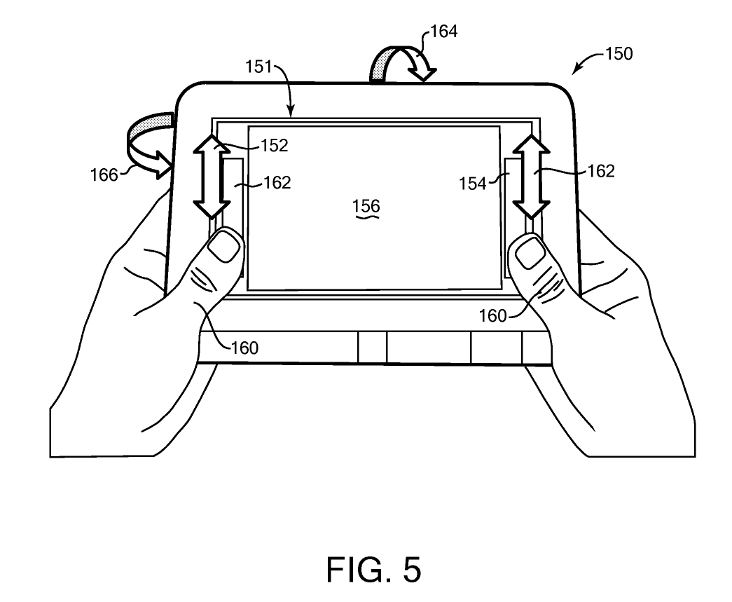

The described control scheme allows a user to zoom a displayed view to a desired level and simultaneously pan that view to a particular desired location of the image. This can greatly aid a user to find a particular area in a viewed image. For example, FIG. 4A is a diagrammatic illustration of a view 120 of an example image 122 displayed on display screen 102. The user desires to both zoom and pan the view so that the portion of the image shown in dashed box 130 fills the entire view. If the user controlled separate, sequential zooming and panning functions as is typical in previous user interfaces, then the user would first have to zoom to a view 126 shown in FIG. 4B, then have to pan the view to the lower left until the view 130 of FIG. 4C is shown; or the user would have to first pan, and then zoom. These separate manipulations of an image can be awkward, especially if the required zooming or panning amounts are large. For example, panning a large image can require numerous and tedious finger swipes until the desired portion of the image is displayed in the view.

In contrast, using a contact motion and a device motion simultaneously as shown in FIG. 3B, a user can change the view 120 of FIG. 4A to the view 130 of FIG. 4C in one direct step, bypassing intermediate displays such as view 126 of FIG. 4B. This allows the user to be more efficient in displayed desired portions of images or other displayed elements. Furthermore, a user can perform both zooming and panning functions using one hand as shown in FIG. 3B, rather than having to hold the device in one hand and perform panning and zooming functions with the other hand as is typical in previous interfaces.

An advantage of using motion sensing to provide input instead of contact motions on a touch screen is that the screen does not become smudged from finger contact when using motion input. In the described embodiment of FIGS. 3A-3B, a compromise is made in which a control region 104 screen portion at the edge of the screen may become smudged, but most of the screen remains remain clean to display images. Thus the control embodiment of FIG. 3B enables an intuitive simultaneous panning and zooming, which can be performed with one hand while smudging only a small portion of the screen.

In some embodiments, the control region 104 as shown in FIGS. 3A and 3B can provide input to the user interface based on positions of the region 104 that corresponding to absolute zoom levels. For example, the leftmost position of the linear strip 104 can correspond to the most zoomed-out level of the display view, while the rightmost position can correspond to a predetermined zoom magnification level, such as 10. In other embodiments, the amount of zooming controlled by the region 104 depends only on the change in position of the user's finger. This allows the user to control zooming without having to look at the control region 104 so as to find a particular location at which to place his or her finger.

In other embodiments, the control region(s) 104 can be implemented as separate input controls or input devices and not as portions of the display screen 102. For example, a capacitive or resistive strip sensor can be used similarly as a control region to sense contact motion of the user.

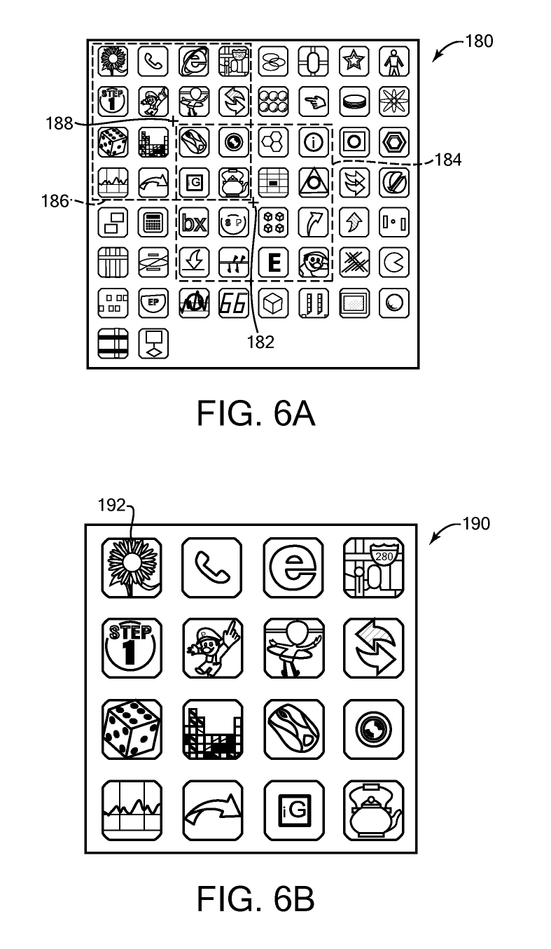

FIG. 5 is a view of a user's hand manipulating a second example 150 of a handheld touchscreen device in accordance with some embodiments described herein. Handheld device 150 is a larger device than the device 100 shown in FIGS. 3A and 3B, such as a touchscreen tablet device. A similar control implementation can be used with tablet device 150 as described above for device 100, to allow user input including device motion sensing and contact motion sensing.

Tablets are often too large and/or heavy to be held with one hand. When a tablet such as device 150 is held with two hands, controlling zooming functions in typical ways is often awkward, such as pinching with two fingers. This awkwardness is avoided in some embodiments described herein, in which a tablet device 150 can provide user interface functions using control regions of the touchscreen 151. For example, the device 150 can include a control region 152 on the left side of the screen, a control region 154 on the right side of the screen, and a central viewing region 156 between the control regions. The control regions 152 and 154 can be displayed as vertical strips similarly to control region 104 of FIG. 3A. In one example, a user's thumbs 160 can be used to contact the control regions 104 and move along these regions to provide contact motion as indicated by arrows 162, while the tablet device 150 is rotated through small angles about the x-axis as indicated by arrow 164 and about the y-axis as indicated by arrow 166, allowing the control of many degrees of freedom simultaneously.

For example, similarly as described above, the motion sensing of device 150 can be enabled by the contact of one or both control regions 152 and 154 by the user. In some embodiments, one of the control regions 152 and 154 can control zooming a view of a image displayed in display area 156, the other of the control regions 152 and 154 can control rotation or orientation of an image in area 156 or other manipulation of the image, x-axis rotation can control panning the view up and down, and y-axis rotation can control panning the view left and right. Other embodiments can provide different interface functions for each of the control regions and device rotation axes.

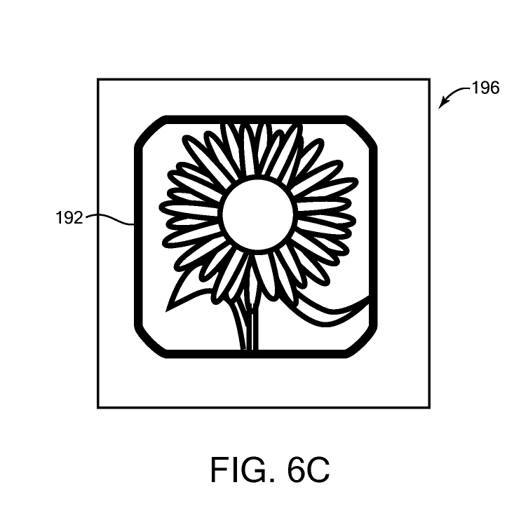

FIGS. 6A-6C are diagrammatic illustrations of sets of icons displayed on a display screen of a handheld electronic device and illustrating interface functions controllable by described embodiments. In this example, zooming and panning functions can be used with handheld devices to aid with display and/or selection of one or more icons in a set of icons displayed on the screen.

According to various embodiments, an icon may be any graphical artifact that can be rendered by a display device, including representations of files (e.g., photographs, other graphics, video, audio, and any other multimedia files), folders, directories, applications, text, keys of an input interface, and any other similar graphical representation that can be visually presented to a user. Icon selection can perform any of a variety of functions for the device, such as initiating an associated application or other software program to execute on the device, indicating which icon and/or associated program or function can be manipulated, displaying a subset of elements associated with the icon, performing a function associated with a software program or the device, changing one or more states of the device, or any other function. Typically icon selection is performed by touching the icon on a touchscreen in touchscreen implementations, and/or by rotating the device to control which icon is selected in a motion sensing implementation. In both cases, a problem arises such that if too many icons are displayed on the screen, they are difficult to touch on the screen or select with motion. If too few icons are displayed on the screen, the number of choices becomes limited, especially when using a small handheld device having a small screen, such as a phone. The user must navigate across many pages of icons, which can become confusing.

For example, FIG. 6A shows a view 180 of displayed icons at a higher zoom level, such that several icons are displayed. The user may have zoomed out the view from a previous, closer view of the icons in order to view more choices. It may be difficult for the user to select one desired icon from this view since the icons are displayed very small. The user can zoom in to display a view having larger, but less icons. In some embodiments, a default zoom can be provided on the center 182 of the screen, which would cause the view to display the subset of icons included in the dashed box 184. The user may wish to zoom instead on a different subset of icons, such as the icons included in the dashed box 186. To display the desired subset, both zooming and panning functions are used.

Using one of the described simultaneous panning and zooming embodiments, the user can zoom out to see many icons as shown in the example view of FIG. 6A. The user can then zoom and pan the view to a closer view showing desired icons to make selecting one of those icons much easier. Thus, for example, the user can simultaneously zoom the view 180 of FIG. 6A to a desired level using a control region of the interface device, and pan the view using rotation of the device about appropriate axes such that the center 188 of the desired icons is in the center of the view. The resulting view 190 is shown in FIG. 6B, after the user has zoomed and panned the view 180 of FIG. 6A.

Thus, many icons (such as 50 or more) can be displayed on the screen at once when zoomed out as shown in FIG. 6A, making it easy for the user to see many or all of the possible icons available to select. Then the user can zoom in the view until only a subset of icons (such as 9 or 12 icons as shown in FIG. 6B) are visible, and select the desired one, e.g. by tapping or otherwise contacting the screen at the desired icon. The selecting process is physically easier at the zoomed level because there are very few icons displayed on the screen at that level and those icons are displayed at a larger size, such that the user will not as easily select a nearby undesired icon.

In some embodiments, the user can zoom in to a predetermined close level to select or activate an element displayed on the screen. In this case, the function of zooming can itself act as a selecting function. The simultaneous zooming and panning features described herein are highly useful for the user to zoom into a particular desired icon. For example, the user can zoom closer than the view 190 of FIG. 6B such that a single icon is displayed in order to select it. If the user wishes to select icon 192, the user can zoom the view using the control region and pan the view using rotation of the device, using the control scheme example described above. The resulting view 196 is shown in FIG. 6C, in which icon 192 fills the screen. At a predetermined zoom level in which the icon 192 fills all of the display area of the screen, or (in alternate embodiments) fills a majority of the screen display area, the icon 192 is selected automatically as if the user had tapped, contacted, or otherwise normally selected the icon for activation. In other embodiments, the selected icon 192 need not fill the display area, but can be centered in the display area. In some embodiments, the icon that is selected is displayed larger than other icons displayed (if any), or is highlighted or otherwise distinguished from the other icons.

In another example, in a picture gallery application, there can be at least three levels of display for images such as pictures or photographs. One zoomed-out level is an album view, in which several albums are displayed based on file folders. A closer view is a thumbnail view, which appears after a particular album has been selected, showing thumbnails (small versions) for each of the pictures in the album. A still closer view is a picture view, in which a particular selected picture itself covers the entire screen. Using the panning and zooming functions described herein, one zooming motion can be used to 1) zoom into an album, transitioning to the thumbnail view; 2) zoom into the thumbnail view, transitioning to the picture view; and 3) zoom into a portion of the picture. This feature allows the user to quickly browse large amounts of data at different levels.

To make the process easier, some aspects of above embodiments can be automated. For example, when viewing a displayed view in which many displayed elements are visible, the user can point the view at a particular element using panning functions and then remove his or her contact with the touchscreen. This removal of contact causes the view to automatically zoom in to some predetermined point, such as a view in which only nine elements are visible, rather than having to zoom in to that view manually. The user can then continue by zooming into a particular “focused” element to select it. Alternatively, if the view is already zoomed in enough, when the user removes contact with the touchscreen, the system can automatically select the focused element, which can be the element in the center of the screen, for example. Alternatively, if the desired item is in focus, the user could tap once on (or otherwise touch) an input control (such as a control region 104 or 152/154) in order to select the element. In another example, in the album view, a small amount of zooming toward one album can cause the album to be temporarily expanded to display its contents (such as thumbnails) (e.g., in the main view or in a separate window), showing the user the pictures in the album without the user having to select the album.

In some embodiments, a software program displaying images on the display screen can be a browser or similar application displaying links that cause other pages (such as web pages or internet pages) or images to be displayed when the links are selected. In current browser applications, if a large amount of text is displayed on a screen on a handheld device, it may be difficult for the user to select a link within a webpage due to the size of the user's finger. Zooming and panning the view as necessary using the techniques described herein, before selecting the link, can make this selection process easier by displaying the desired links at a larger size. Furthermore, as the user navigates various webpages via various links, the system can build a history tree of visited webpages that can be used to display options for the user for navigation or selection. For example, if the user zooms out far enough from a webpage, other recently visited webpages can be displayed, e.g., in thumbnail form or reduced size. Webpages from the same site can be displayed as stacked in a logical fashion indicating their hierarchy within the website. With limited memory available on the device, a small number of webpages may be cached and displayed; with more memory, many webpages can be simultaneously displayed. In this way, the user can zoom out from one webpage and, with the same fluid motion (e.g., switching directions of a control motion in the control region 104 or 152/154 or switching rotation direction of the device, and panning simultaneously), zoom into another related or unrelated webpage. In some embodiments, zooming out from a webpage can also be configured to reveal bookmarked webpages or known “favorite” webpages that are displayed and can be selected or zoomed into.

In another embodiment, a menu can be displayed on the display screen, the menu formed as a list of elements such as text items (e.g., links), each of which may transition to a particular submenu of text items (or other elements) when selected by the user. The menu is conventionally navigated by viewing one list of items at a time, in which the user must search for a desired item by selecting or drilling down through hierarchical submenus until the desired item is encountered. The described zooming and panning techniques can be used to more easily navigate such menus, and features can be included similarly to the web page navigation described above. For example, zooming out can cause the display of part of or an entire menu tree organized to show the hierarchy of menus and submenus. If the user is searching for an item that is in a completely different branch of the menu tree, instead of pressing a back button several times and then selecting a sequence of submenus, the user can use the zooming and panning techniques to zoom out until the entire the menu tree (or a large part of the menu tree) is visible and then zoom into the desired branch of the tree, thus bypassing many conventional steps in menu navigation. The combined sensor data from motion and contact sensors can also be used for other interaction with a menu, such as item or menu selection similar to icon selection described above, menu traversal or additional menu options, etc.

Other applications can also take advantage of the simultaneous panning and zooming functions described herein. For example, in some embodiments, a map application can display a view of an image of a map, landscape or other representation of physical space, where the view can be navigated using the simultaneous panning and zooming with the user panning across areas of the map and zooming into areas that for greater detail, e.g., to display street names or labels for places of interest, or to zoom into a street-level 3D or photograph view of a location. This allows a user to much more quickly navigate across and zoom into large map areas that currently require an awkward sequence of panning swipes and zoom pinches to navigate with a touchscreen. Other map functions can also be used and mapped to the motion data and/or contact data for simultaneous manipulation, such as rotating or tilting the map view or portions thereof, switch to other map display modes, etc.

In some embodiments, a calendar application running on the handheld device can also use the simultaneous panning and zooming functions described herein. For example, the user can zoom out from a day view of the calendar displaying a day schedule on the entire screen and transition smoothly to a week view, then a month view, and then a year view (and/or multi-year view). The user can also then zoom all the way in from the year view to some other day view, with one fluid movement combining panning and zooming.

Similar techniques can also be used when displaying the user's home screen or application launcher screen. Commonly this home screen comprises several screens of icons, a separate area containing all other applications, and a notification area containing important notifications such as voicemail and email notifications. The user is able to navigate and browse all of these elements smoothly and quickly using the simultaneous panning and zooming techniques described herein.

Other applications can similarly use the described combined sensor data and interaction techniques, such as a camera application allowing zooming and panning functions, word processing, browser, or other applications changing a page display based on these inputs, applications displaying a virtual keyboard or keypad allowing selection of keys or characters (and auto-completion list), telephone applications, game applications allowing multiple degrees of freedom of input, authentication applications that can authenticate a user based on the combined sensor data, or an application controlling an external system based on movement of the device and contact motion of the user.

A yaw movement of the device as shown in FIG. 1 simultaneous with other inputs can also be used in some embodiments, where motion data from the yaw sensor(s) can be included in the combined data used for control of interface functions. For example, simultaneous panning controlled by pitch and roll motion of the device and zooming controlled by contact motions on a touchscreen can be combined with display orientation of an image controlled by yaw motion of the device. The orientation control can determine whether the image is displayed in landscape mode (longer dimension of screen is top and bottom) or portrait mode (shorter dimension is top and bottom), for example. In some embodiments, when the user releases contact with the touchscreen, the orientation of the image is snapped to the closest desired orientation based on the yaw motion or yaw position of the device. Yaw control can be used to control other functions in other embodiments, such as zooming, while an input control (such as a control region) can control a different function with a contact motion, such as display orientation.

In other embodiments, roll, pitch, and/or yaw degrees of freedom may be combined with degrees of freedom from the touchscreen and/or other input control devices and mapped to other functions. For example, the user may use the touchscreen to control a panning function by moving a finger in a contact motion along the touchscreen in x and y axes (and/or in displayed control regions of the touchscreen in some embodiments), while simultaneously using motion of the device to provide a zoom function. In one example, the zooming function can be a rotation around some axis, such as a pitch rotation. Since the user may provide cross-axis movement of the device, whether intended or not (e.g., movement in two rotation axes, such as roll and pitch), some embodiments can use a threshold to determine which axis is considered to be the primary sensed axis for the motion, and motion in the other axis can be ignored.

Other motions of the device besides rotation can also be used to provide at least a portion of the motion data used in the combined data for interaction with the device. For example, linear motion of the device can be used to control panning or zooming instead of the rotation described above. For example, in-and-out movement along the z axis shown in FIG. 1 can control zooming, or alternatively linear movement along the x-axis or y-axis. In other embodiments, motion gestures can be recognized from motion data, where a motion gesture is a motion or set of motions of the device which, when recognized by the device to have occurred, triggers one or more associated functions of the device or changes one or more states of the device. Such motion gestures can include tapping the device, shaking the device, or moving the device in a predetermined pattern in space, such as a circle, figure-eight, right angle, rectangle, etc. For example, a contact motion of the user using the input control device to scroll displayed elements can be combined with a tap motion used select a particular element once it has scrolled into a particular position on the display screen. Some embodiments of motion gesture recognition are described in copending U.S. patent application Ser. No. 12/252,322, incorporated by reference herein in its entirety.

Other embodiments can provide other interactions, other multiple interactions with a visual element can be provided simultaneously based on the combined sensor data. Such interactions can include selecting or highlighting an element, moving an element, reordering the element in a list of elements, starting an application associated with the element, scrolling lists or sets of visual elements, deleting or adding visual elements, converting visual elements to different visual elements, or any other activities associated with the manipulation, activation or other interaction with such visual elements. For example, movement of a visual element or indicator (cursor, insertion point, highlighter, etc.) on the screen can be a substantially-linear direction or along a curved-path in response to rotational movement of the device, and/or linear movement of the device. The visual elements described herein can be one element or set of elements, such as icons, menus, menu bars, windows, window bars, buttons, boxes, images, links, hyperlinks, text, symbols, shapes, lists of items (e.g., songs, photos, videos, emails, text messages), or other elements displayed for user review or interaction. The interactions can also include initiating or exiting an application, and/or switching between at least two applications. Several example interactions and other features which can be used with the embodiments described herein are described in co-pending U.S. patent applications Ser. Nos. 12/398,156 and 12/485,823, both incorporated herein by reference in their entireties.

Several embodiments described above combine data from a set of motion sensors with a touchscreen as input control. In other embodiments, the input control may instead be a capacitive strip, a trackball, series of buttons, an optical device, a mechanical wheel, or other controls as described above which sense the movement of the user, such as a user's finger moving along a surface or moving a manipulandum.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art.

What is claimed is:

1. A handheld electronic device, the device comprising:
a display operative to display an image;
an input control operative to sense a contact motion of the user with the device;
a set of motion sensors sensing rotational rate of the device around at least three axes of the device and linear acceleration along at least three axes of the device; and
a subsystem capable of facilitating interaction with the device based on combined sensor data, the combined sensor data including motion data derived from at least one of the motion sensors and contact data derived from the contact motion sensed by the input control.

2. The electronic device of claim 1, wherein the input control is a touchscreen sensor of the display, and wherein the contact motion is motion of a user contacting a surface of the display.

3. The electronic device of claim 1, wherein the input control is one of the following: a capacitive sensor strip, a trackball, an optical sensor, a mechanical wheel, or a series of buttons.

4. The electronic device of claim 1, wherein the motion sensors sensing rotational rate are gyroscopes and the motion sensors sensing linear acceleration are accelerometers.

5. The electronic device of claim 1, wherein the combined sensor data including the motion data and the contact data is derived from simultaneous contact motion and device motion provided by the user.

6. The electronic device of claim 2, wherein the display is controlled to display at least one control region that is operative to provide the contact data based on the touch of the user in the at least one control region.

7. The electronic device of claim 6 wherein the at least one control region is operative to enable the motion data to be included in the combined sensor data to facilitate the interaction with the device.

8. The electronic device of claim 6, wherein the control region is at least one strip region approximately at a side of the display.

9. The electronic device of claim 6, wherein user sliding contact on the surface of the display in the control region is operative to control a zooming function for an image displayed by the display.

10. The electronic device of claim 9, wherein rotation of the device around an x-axis of the device as sensed by the motion sensors is operative to control a first panning function for the image displayed by the display.

11. The electronic device of claim 10, wherein rotation of the device around a y-axis of the device as sensed by the motion sensors is operative to control a second panning function for the image, the second panning function operating along a different axis of the displayed image than the first panning function.

12. The electronic device of claim 1, wherein
the motion data is used to control a panning function for an image displayed on the display, and
the contact data is used to control a zooming function for the image displayed on the display.

13. The electronic device of claim 1, wherein
the motion data is used to control a zooming function for an image displayed on the display, and
the contact data is used to control a panning function for the image displayed on the display.

14. The electronic device of claim 9, wherein a displayed element of the image is selected in response to a predetermined zoom level of the zooming function being reached.

15. A method for providing interaction with a handheld electronic device, the method comprising:
sensing contact motion input from a user using an input control of the handheld electronic device;
sensing motion of the device around at least one axis of the device using a set of motion sensors, the set of motion sensors operative to sense rotational rate around at least three axes of the device and linear acceleration along at least three axes of the device; and
providing interaction with the device based on combined sensor data, the combined sensor data including motion data derived from at least one of the motion sensors and contact data derived from the contact motion sensed by the input control.

16. The method of claim 15, wherein providing interaction with the device includes modifying or selecting at least a portion of an image displayed by a display of the handheld electronic device based on the combined sensor data.

17. The method of claim 16, wherein the input control is a touchscreen sensor included in the display, and wherein the contact motion is motion of a user contacting a surface of the display.

18. The method of claim 17, wherein the display is controlled to display at least one control region that senses the contact motion input from the user and is operative to provide the contact data based on the touch of the user and to enable the motion data to be included in the combined sensor data to facilitate the interaction with the device.

19. The method of claim 15, wherein
the motion data is used to control a panning function for an image displayed on the display, and
the contact data is used to control a zooming function for the image displayed on the display,
wherein the panning function and the zooming function are provided simultaneously to create the combined sensor data.

20. A storage medium including a software program, the software program capable of running at least partially on a handheld electronic device,
wherein the device comprises:
a touchscreen display operative to display an image and to sense contact on a surface of the touchscreen display; and
a set of motion sensors sensing rotational rate around at least three axes and linear acceleration along at least three axes,
wherein the software program is capable of facilitating interaction with the device based on combined sensor data, the combined sensor data including motion data derived from at least one of the motion sensors and contact data derived from the contact sensed by the touchscreen display.
